(19) United States
(12) Patent Application Publication
(10) Pub. No.: US 2008/0061457 A1
(43) Pub. Date: Mar. 13, 2008

(54) Manufacturing Method of Acrylic Optical Fiber with Improved Environmental Stability

(75) Inventor: James K. Walker, Gainesville, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(73) Assignee: Nanoptics, Incorporated, Gainesville, FL (US)

(21) Appl. No.: 11/661,570

(22) PCT Filed: Sep. 9, 2005
(86) PCT No.: PCT/US05/32343

§ 371 Date: Feb. 28, 2007

Related U.S. Application Data
(60) Provisional application No. 60/608,794, filed on Sep. 9, 2004.

(51) Int. Cl. B29D 11/00; G02B 6/02

(52) U.S. Cl. 264/1.24

(57) ABSTRACT

The subject invention pertains to a method and apparatus for manufacturing a plastic optical transmission medium. The subject invention also relates to materials for use in producing plastic optical transmission medium. The subject method can allow continuous high-speed production while controlling the refractive index profile, step or graded, of the optical transmission medium. In a specific embodiment, the medium POTM can have high optical transmission, and be able to operate in conditions up to 125° C. at 95% R.H. In a specific embodiment of the subject invention, two or more concentric cylinders of transparent polymer melts, of which at least one is a cross-linkable material, can be utilized to produce a plastic optical transmission medium. In addition, zero, one, or more transparent, nonreactive, low molecular weight diffusible additive(s) can be added to zero, one, or more of the transparent polymer melts to provide a graded refractive index profile. The molecular weights and chemical structures of the index modifying additives can be chosen to ensure their diffusion constants are low enough to provide a stable refractive index profile at the desired operating temperature of the fiber. The cylinders of melt can be extruded into a solidified polymeric tube via, for example, a cross-head type of die. The tube containing the melt materials can be maintained at high temperature for a specific time period, such that the cross-linking can occur and, optionally, the additives can diffuse within the polymeric tube.

### CROSS-REFERENCE TO A RELATED APPLICATION

This application claims priority from U.S. Provisional Application Ser. No. 60/608,794 filed Sep. 9, 2004.

### BACKGROUND OF INVENTION

Embodiments of the invention relate to the materials, processes and related manufacturing methods for continuous, high speed production of plastic optical fiber used for data communication under adverse environmental conditions including high temperature and high relative humidity.

Polymer Optical Fibers (POF) are increasingly used in data communications for short range applications with link lengths typically less than 100 m. Specific applications are in the areas of automotive and industrial controls. Currently, the maximum operating temperature of the typical polymethylmethacrylate (PMMA) based POF is about 85° C. It is desirable to increase that temperature up to about 125° C. which would permit the use of POF in the engine compartment of automobiles and challenging industrial and aero-space applications. Simultaneously, it is desirable for POF to be stable when used in atmospheres with relative humidity up to 95%.

There are other desirable characteristics for a POF solution to these environmental challenges. Examples of such desirable characteristics include:
1. Optical attenuation at 650 nm less than about 400 dB/km. Visible light for data transmission is preferred to facilitate ease of testing;
2. Numerical aperture greater than 0.4 and diameter greater than about 0.2 mm and preferably greater than about 0.5 mm, to facilitate the use of low cost connectors and efficient light acceptance from the light emitting diode;
3. A minimum bend radius of about 10 mm;
4. Easy to terminate and connectorize;
5. Robustness, allowing stretching, bending, and twisting during installation.
6. Ability to withstand mechanical stress, either static or dynamic, which may occur during the installation process and service repairs within an automobile engine compartment;
7. Ability to withstand the high vibration environment encountered throughout the twenty year design lifetime of an automobile;
8. Good resistance to a variety of chemicals;
9. Meet the comprehensive standards (VDI/VDE) established in Europe for the characterization and testing of plastic optical fibers and, in particular, meet the specific standards for use in the auto engine compartment;
10. Low cost of manufacture. A POF cable manufacturing process that is high speed and continuous can reduce labor and time needed to produce the POF cable and reduce costs.

A detailed analysis of these and other parameters has been made by SAE. (SAE J1211:1978, “Recommended environmental practices for electronic equipment design.” and Daum, W. et al., “Reliability of Step-Index and Multi-Core POF for Automotive Applications,” POF 2003, International Conference Proceedings, Seattle, Wash., USA p. 6-9, 2003.)

Despite almost twenty years of research and development effort, no commercially available POF cable is available that meets a majority of the above requirements. Several development efforts have been made to produce a plastic optical fiber with good heat resistance.

U.S. Pat. No. 4,810,055 discloses a heat-resistant optical fiber having a core co-polymer with high glass transmission temperature. Good results were obtained at up to 125° C., but no study was made at high relative humidity.

U.S. Pat. No. 4,575,188 discloses a heat resistant plastic optical fiber having a standard core/clad structure surrounded by a sheath material that has been cured by irradiation with ultraviolet rays. This sheath was found to substantially reduce shrinkage of the standard core/clad fiber when the cable was exposed to 120° C. Long term tests at high humidity were not performed.

U.S. Pat. No. 4,779,954 discloses a plastic optical fiber with good resistance to heat and humidity for particular wavelengths in the near infra-red range. The fiber core is deuterated methyl methacrylate. The cost of this type of fiber is prohibitive for commercialization.

U.S. Pat. No. 5,204,435 discloses a stress, heat, and humidity resistant plastic optical fiber having a core of an organopolysiloxane mixture that is cross-linkable. The low viscosity mixture is put under pressure and made to fill a fixed length of fluorinated tubing. The tube containing the mixture is maintained at 100° C. to 150° C. for a time of about three hours or longer to effect the cross-linking of the mixture. The fibers were found to exhibit satisfactory performance at 60° C. and 90% relative humidity and responded well under physical stress. In addition to the limited range of testing of these fibers, the batch production process is unlikely to lead to an economical manufacturing process.

An important demonstration was made by a group at Hitachi (Taneichi, S. et al., “Development of Heat Resistant POF for Automobile Data Communications,” Proceedings of the POF '94 Conference, Yokohama, 1994, p 106; The result of this reference is also quoted by H. Poisel in “Optical Fibers for Adverse Environment,” Proceedings of the POF 2003 Conference, Seattle, Wash., USA, p. 10. In addition, in that paper, the results of other recent research is quoted.) in 1994. Their optical measurements for a cross-linked PMMA fiber are shown in FIG. 1. The fiber optical attenuation at 650 nm is shown as a function of time. The fiber was maintained at 130° C. in a dry atmosphere throughout the duration of the 700 hour test. The optical attenuation fell rapidly in the first 20 hours presumably due to initial stress relief of the PMMA in the fiber core, after which there was a much more gradual approach to an asymptotic value of 300 dB/km.

The results of a German study (Ziemann, O. et al., “Results of a German 6,000 Hours Accelerated Aging Test of PMMA POF and Consequences for the Practical Use of POF,” Proceedings of the POF 2000 Conference, Cambridge, Mass., USA, p. 173) of the effects of 95% humidity at 92° C. on standard non-cross-linked PMMA POF revealed a typical lifetime of about 2000 hours. At that lifetime, the optical transmission started to drop rapidly. This effect was interpreted as physical damage of the polymer structure due to an increase in free volume as the water content of the POF increased rapidly. This interpretation was consistent with previous investigations (Kaino, T., “Influence of water absorption on plastic optical fibers,” Applied Optics, Vol. 24, No. 23, pp. 4192-4195, 1985, and Daum, W. et at., “Influence of environmental stress factors on transmission loss of polymer optical fibers,” POF '94 Conference, Hague, pp. 94-98, 1993) over many years. At 20° C., PMMA contains water at about 1.5% wt/wt. This water is partially dissolved between molecular chains in the polymer and partially exists in microvoids in the material. At high temperature and high humidity more water molecules diffuse into the material and cause existing microvoids to expand and new microvoids to develop between the polymer chains of the thermoplastic PMMA.

In general, it is not possible to extrude a cross-linked polymeric system. However, an effective process for manufacturing a cross-linked PMMA based light pipe has been disclosed in several patents: Bigley et al., U.S. Pat. Nos. 5,406,641 and 5,485,541 and Ilenda et al., U.S. Pat. No. 6,207,747, and U.S. Provisional Patent Application Ser. No. 60/27,942. These patents disclose a cross-linkable polymer mixture containing a multi-functional monomer containing silicon, water, an organotin catalyst and a stabilizer containing phosphorus. Although such materials appear to offer good stability against optical degradation from the use of very high light intensity in the light pipe, the optical attenuation is limited to about 1000 dB/km. In all of these methods, a cross-linkable core polymeric material was co-extruded within a fluoropolymer cladding cylinder. The core/clad composite was subsequently and separately cured in a batch process.

Accordingly, there is a continuing need for a low cost, high speed, continuous manufacturing method of cross-linked PMMA core plastic optical fiber with optical attenuation less than 400 dB/km. By control of the specific choice of POF materials and their chemical processing, together with control of the parameters of a high speed, continuous manufacturing process, a high temperature, high humidity, long lifetime, mechanically stable POF can be produced economically.

### BRIEF SUMMARY

The subject invention provides a method of manufacturing a plastic optical fiber in which a structured polymeric tube has at least two concentric cylinders of polymeric material within it, wherein at least the core cylinder of the two concentric cylinders is a cross-linkable polymeric material. The second concentric cylinder has a lower refractive index than the core cylinder material. The structured, or solid, polymeric tube can then be heated to cause cross-linking of the inner material to occur. The temperature to which the structural polymeric tube is heated should be such so that its structural integrity is maintained. In a specific embodiment, the temperature to which the solid polymeric tube is heated is below the tube's melting temperature. The temperature should also be adequate to effect the cross-linking of the inner polymeric materials. By controlling the temperature and time period of the heating process, the cross-linking can be completed.

The subject patent incorporates by reference the methods disclosed in U.S. patent applications: U.S. patent application Ser. No. 10/804,982 (U.S. Published Application No. 2004-0179798), U.S. patent application Ser. No. 10/775,567 (U.S. Published Application No. 2005-0062181) and U.S. Provisional application Ser. No. 60/503,201; and teaches the manufacture of this type of plastic optical fiber.

In a specific embodiment of the subject invention for the production of step-index fiber with a maximum operating temperature/humidity of 125° C./95% the cross-linkable core material can be PMMA based and the core material can be surrounded by a fluoropolymer. These two polymeric cylinders are surrounded by an outer structural polymeric tube. Embodiments of the invention can use a cross-linked PMMA so as to maintain the structural integrity of the material at high humidity and high temperature. Generally, the greater the degree of cross-linking of the PMMA, the greater the operating temperature/humidity capability of the resulting POF. On the other hand, as the degree of cross-linking of the PMMA is increased there can be decreased flexibility of the POF. Thus, the choice of materials and chemical processing of the POF material can be selected to meet the POF specifications for a particular application.

In a specific embodiment of the subject invention for producing graded-index plastic optical fiber with resistance to extreme environments, the cross-linkable core PMMA based material can incorporate an index-increasing additive. The second concentric cylinder can be a cross-linkable PMMA based material which may incorporate an index-lowering additive. These two polymeric cylinders can then be surrounded by an outer structural polymeric tube. The structural polymeric tube can then be heated following a temperature versus time cycle that permits the development of a graded-index profile and a cross-linked polymeric optical material.

In a specific embodiment of the subject invention the structural tube having the polymeric optical fiber within it can be wound continuously on a rotating heated drum for a number of turns which can provide an adequate time duration, at a given fiber production rate, to achieve the desired step-index or graded-index fiber. Alternative methods of providing energy to the fiber to effect the cross-linking are well known in the art and can be used. In a specific embodiment, material for the structural tube can include a semi-crystalline polymer or a ultra-violet cured cross-linkable semi-crystalline polymer.

For increasing the heat resistance, further jacketing of the tube is effective. As jacketing materials, polyolefins such as polyethylene, polypropylene, crosslinked polyolefin, polyvinylchloride, polyamides such as Nylon 12 or polyester elastomers such as polyethylene/methylene terephthalate copolymer may be used.

### BRIEF DESCRIPTION OF DRAWINGS

FIG. 1 shows the measured optical attenuation of a cross-linked PMMA based step-index fiber versus time, where the ambient temperature is, 130° C. and the fiber is in a dry atmosphere.

FIG. 2 shows a schematic illustration of an apparatus for manufacturing a plastic optical fiber in accordance with the subject invention with extreme resistance to harsh environments.

FIG. 3 shows a schematic illustration of a cross-section of a die which can be used in conjunction with the apparatus shown in FIG. 2, in accordance with the subject invention.

FIG. 4 shows a schematic of the cross-section of an extreme environment resistant POF, in accordance with the subject invention, where polymeric composition 1 is a cross-linked acrylic based material, polymeric composition 2 is a fluorinated polymer known as THV and polymer structural tube 3 is PBT.

FIG. 5 shows a schematic of the cross-section of an extreme environment resistant multi-core POF with very high flexibility in accordance with a specific embodiment of the subject invention, where each hexagonal POF structure has a core, cladding, and structural polymeric materials, and each hexagonal POF structure is mechanically separate from the other, where the seven structures are within a separate 1 mm diameter PBT structural tube.

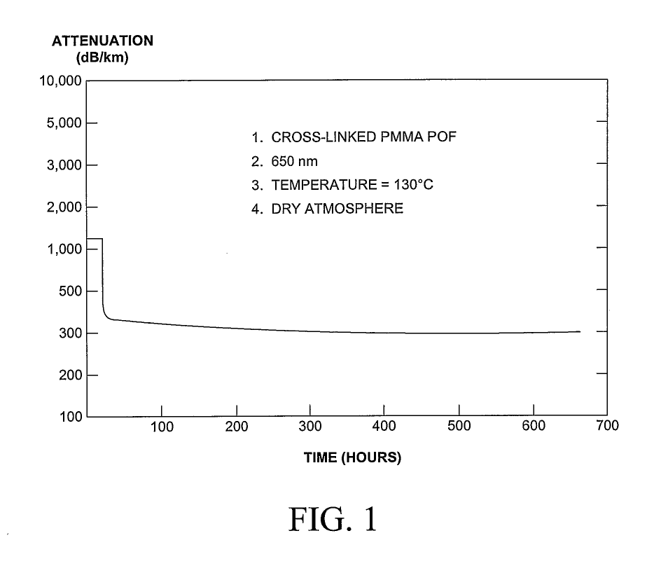

### DETAILED DISCLOSURE

The subject invention pertains to a method and apparatus for manufacturing a plastic optical transmission medium. The subject invention also relates to materials for use in producing plastic optical transmission medium. The subject method can allow continuous high-speed production while controlling the refractive index profile, step or graded, of the optical transmission medium. In a specific embodiment, the medium POTM can have high optical transmission, and be able to operate in conditions up to 125° C. at 95% R.H. The POTM can also have mechanical properties which meet the requirements of a specific application.

By control of the specific choice of POF materials and their chemical processing, together with control of the parameters of a high speed, continuous manufacturing process, a high temperature, high humidity, long lifetime, mechanically stable POF can be produced economically.

In a specific embodiment of the subject invention, two or more concentric cylinders of transparent polymer melts, of which at least one is a cross-linkable material, can be utilized to produce a plastic optical transmission medium. In addition, zero, one, or more transparent, non-reactive, low molecular weight diffusible additive(s) can be added to zero, one, or more of the transparent polymer melts to provide a graded refractive index profile. The molecular weights and chemical structures of the index modifying additives can be chosen to ensure their diffusion constants are low enough to provide a stable refractive index profile at the desired operating temperature of the fiber. Preferred additives are: diphenyl sulphide and methyl perfluoro octanate. These additives are discussed in U.S. patent application Ser. Nos. 10/804,982 (U.S. Published Application No. 2004-0179798) and 10/775,567 (U.S. Published Application No. 2005-0062181), which are hereby incorporated by reference in their entirety. Many other suitable additives that are well known in the art of manufacture of graded-index plastic optical fiber can be utilized in accordance with the subject invention. The cylinders of melt can be extruded into a solidified polymeric tube via, for example, a cross-head type of die. The tube containing the melt materials can be maintained at high temperature for a specific time period, such that the cross-linking can occur and, optionally, the additives can diffuse within the polymeric tube.

The chemical composition of the polymers can be selected to meet the desired optical, thermal, relative humidity and mechanical properties of the resulting optical transmission medium.

In a specific embodiment, some of the desired properties of a high-temperature fiber for operation in an automobile engine compartment include:

| 1. | Optical Attenuation | ≦400 | dB/km |
|---|---|---|---|
| 2. | Maximum Long Term Operating Temperature | 125° | C. |
| 3. | Maximum Long Term Operating Relative | 95% | |
| | Humidity | | |
| 4. | Numerical Aperture | >0.4 | |
| 5. | Optical Fiber Diameter within the range | 0.2 mm-1.0 mm | |
| 6. | Minimum Bend Radius | 10 | mm |
| 7. | Production Rate of Cable | ≧10,000 | m/hr |

The subject invention can utilize organic polymers, partially fluorinated and/or perfluorinated polymers to manufacture step/graded-index POF with one or more of the desired properties.

A preferred choice of organic polymer suitable for the above type of fiber is in the methacrylate family. Other amorphous organic polymers may be used such as polystyrene, polycarbonate and copolymers thereof. These polymers and others are addressed in U.S. patent application Ser. No. 10/804,982 (U.S. Published Application No. 2004-0179798).

In a specific embodiment of the subject invention, a suitable cross-linkable core polymer mixture incorporates:
1) from 70 to 99 weight percent of polymerized units of methylmethacrylate.
2) from 0.1 to 28 weight percent of polymerized units of an asymmetric di-functional comonomer, one functional moiety of which is methacrylate or ethyl acrylate and has reacted to form the co-polymer. In an embodiment, this one functional moiety has reacted in the temperature range from about 60° C. to about 100° C. to form the co-polymer. The second functional moiety of the comonomer is able to be activated at a higher temperature, in the range 120° C. to 180° C. and preferably 140° C. to 160° C. An example of such a comonomer is an allyl methacrylate, the structure and properties of which will be discussed below. A specific example of such a comonomer is propoxylated (n) allylmethacrylate. The structure for n=2 is shown below.
3) from 0 to 15% of ethylmethacrylate or ethylacrylate the purpose of which is to confer a desired degree of flexibility to the final polymer.

Suitable cross-linkable core polymer mixtures may incorporate any amorphous organic, partially fluorinated or perfluorinated polymer. Such polymers include polycyclohexyl methacrylate, polyphenyl methacrylate, polytrifluoroethyl methacrylate, poly (2,2,3,3-tetrafluoropropyl-α-fluoroacrylate), polystyrene and its derivatives, polycarbonate and its derivatives. Examples of suitable perfluorinated amorphous polymers are 2,2-bistrifluoromethyl-4,5-difluoro-1,3-dioxole (PDD) homopolymer and its derivatives, perfluorocyclobutyl (PFCB) polaryl ethers and derivatives and other perfluorinated polymers discussed in U.S. patent application Ser. No. 10/775,567 (U.S. Published Application No. 2005-0062181).

In a specific embodiment of this invention, a candidate asymmetric di-functional comonomer is propoxylated (2) allylmethacrylate. The structure of this compound is shown below: 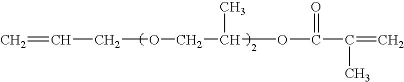
The methacrylate moiety of the above comonomer has a reactivity at 80° C. similar to the MMA monomer base material. The allyl moiety has low reactivity at 80° C. Use of an azo rather than peroxide initiator is selective to the methacrylate double bond. An azo initiator such as AIBN may be used at a concentration of 0.01% to 1% by weight, together with a chain transfer agent such as n-butyl-mercaptan or other such agents which are well known in the art. Moreover, a trace amount of heat stabilizer or antioxidant, which does not degrade the light transmission, is also included within the scope of the present invention.

At 150° C. the allyl moiety can be reacted using a peroxide initiator such as di-tert-butyl peroxide. The result is a cross-linked highly stable polymeric structure.

An advantageous property of the propoxylated(2)allyl methacrylate cross-linker is the flexible propoxylated (2) link between the two functional moieties each of which is covalently bonded to a polymer chain. This flexible link confers some degree of motion of one chain relative to another and hence some flexibility to the optical fiber. In general, the propoxylated link can be formed from 1, 2, 3 . . . units and provide the fiber manufacturer some control over the flexibility. It must be noted that the longer the propoxylated link the greater the propensity for water absorption in the polymer. A single or preferably a double propoxylated link is adequate to achieve the design flexibility for POF in the auto application.

There are other candidate asymmetric di-functional comonomers which may be used in the subject invention. In general, they are preferentially in the class of compounds composed of a functional alkene group connected to (methyl)methacrylate group. Within the alkenyl group there are three sub-groups of compounds composed of vinyl, allyl and isopropenyl. The specific asymmetric di-functional comonomer, propoxylated (2) allylmethacrylate disclosed above, is an example from the second of the above sub-groups. That specific asymmetric di-functional comonomer is chosen because the reactivity of the allyl group is very low at 80° C. and adequate at 150° C. Other candidate monomers with an alkenyl functional group and link moieties different from propoxyl (2) may be chosen if their reactivities at 80° C. and 150° C. are suitably different. In particular, if the alkene reactivity is too high at 80° C. then gelling can occur in the initial polymerization and extrusion becomes difficult. Conversely, if the alkene reactivity at 150° C. is too low then the cross-linking will not proceed to completion within a reasonable temperature/time cycle.

More generally, within the alkenyl group there are other potential functional moieties which may be used in an asymmetric di-functional comonomer. These functional moieties belong to the sub-group called cycloalkenes and their derivatives. Comonomers based on these functional moieties are less desirable than the alkenes due to their greater propensity to have some optical absorption in the visible range.

It can be seen that for someone skilled in the art, there is a broad class of potential candidates for asymmetric di-functional comonomers that can be utilized in accordance with the subject invention. There is the ability to design the optimum reactivity of the alkene group for any desired curing temperature/time cycle and there is the ability to control the flexibility of the cured polymer.

More generally, there are functional moieties other than alkenes. For someone skilled in the art, asymmetric di-functional comonomers may be designed with such moieties as well.

It should also be understood that, in accordance with the subject invention, it is possible to use tri-functional comonomers in which one functional group could be (methyl)methacrylate and the other two functional groups could be alkene or other groups.

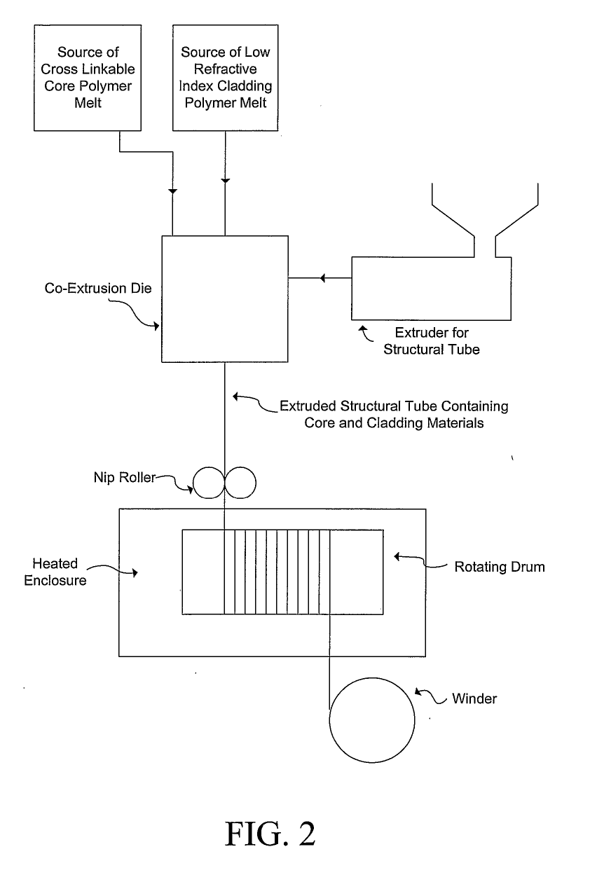

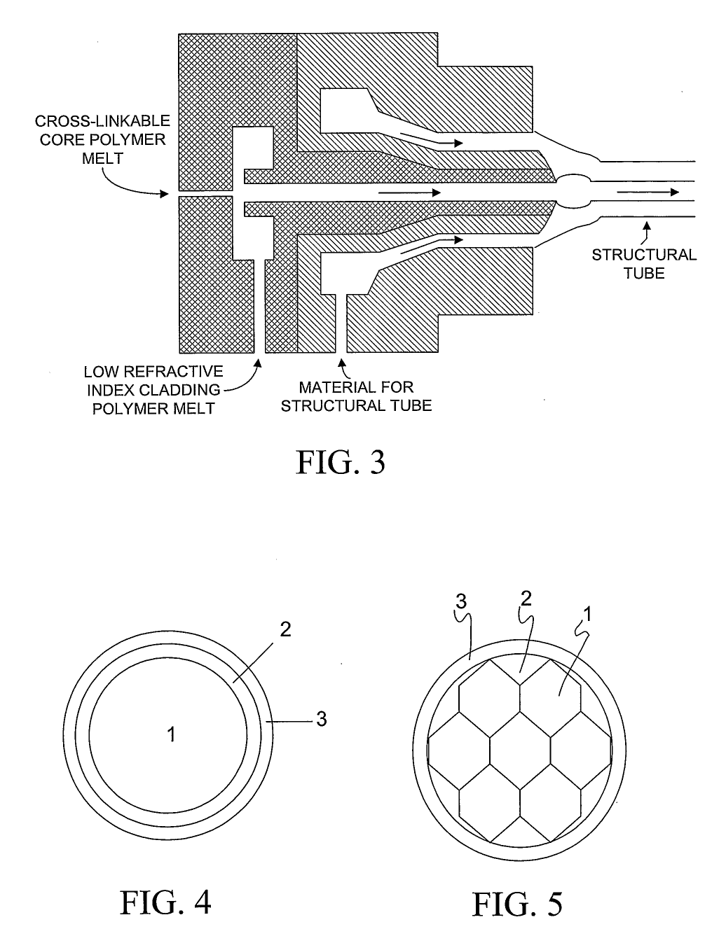

In an embodiment, the cross-linkable core polymer mixture can be prepared in a constant flow, continuously stirred tank reactor by standard methods well known in the art. The output of the reactor can be pumped into an extruder. The polymer mixture can be devolatized to remove unreacted monomer and other low molecular weight moieties in the mixture. After devolatization and prior to extrusion 0.03% to 3% weight of a high temperature initiator can be added to the mixture. An example of such an initiator is Di-tert-butyl peroxide which has a one hour half-life temperature of 141° C. The core polymer mixture can be extruded through a co-extrusion die, for example, in a system shown schematically in FIG. 2. A schematic of a specific embodiment of a co-extrusion die that can be utilized with the subject invention is shown in FIG. 3.

Suitable cladding polymers include, for example, thermoplastic, cross-linkable polymer mixtures, and/or semi-crystalline polymers. Examples of thermoplastic cladding materials are polymers of methacrylate derivatives with at least one hydrogen atom being substituted with a fluorine atom, polymers of styrene derivatives with at least one hydrogen atom being substituted with a fluorine atom, copolymers of these methacrylate and styrene derivatives, fluorine substituted polycarbonate. Examples of semi-crystalline polymers are polyvinylidene fluoride, vinylidene fluoride-tetrafluoroethylene copolymers, vinylidene fluoride-hexafluoropropylene copolymers, vinylidene fluoride-tetrafluoroethylene-hexafluoropropylene terpolymers, silicone resins and ethylene-vinyl acetate copolymers.

The core and cladding polymer cylinders can be extruded within the extruded structural tubing, for example, as indicated by the die shown in FIG. 3. Optional structural polymeric tubing materials are discussed in U.S. patent application Ser. No. 10/775,567 (U.S. Published Application No. 2005-0062181). The structural tubing preferably retains its structural mechanical properties up to a temperature needed to complete the cross-linking. In the subject invention, the tubing is preferably be held at a temperature in the range of about 130° C. to 170° C. to complete the cross-linking. A suitable structural polymer material for the subject invention is polyethylene terephalate (PET).

In a specific embodiment, the POF fiber can be wound continuously on a rotating heated drum as shown in FIG. 2. The number of POF turns on the drum can be controlled to give the desired time period for cross-linking to occur in the temperature range of, for example, 130° C. to 170° C. The cross linking can be effected by heat, ultraviolet radiation, any form of radiation energy, or combinations thereof.

It has been found to be beneficial to the optical characteristics of the POF to limit the weight average molecular weight of the cross-linkable core polymer mixture to less than 60,000, preferably less than 50,000, and most preferably less than 40,000. In that case, the viscosity of the melt is reduced and the maximum necessary extrusion temperature was found to be less than 210° C., preferably less than 190° C., and most preferably less than 180° C. As a result, there is reduced polymer thermal degradation in the extrusion process.

It has been further found that a degree of cross-linker comonomer of at least 5 to 10 weight percent is preferable for maintaining adequate structural integrity in severe adverse environmental conditions.

In another embodiment of the subject invention at least 5 to 10 weight percent of ethylmethacrylate is advantageously incorporated in the cross-linkable core polymer in the di-functional comonomer (instead of the methacrylate functional moiety) or as a separate comonomer to provide additional flexibility of the POF product.

It is a preferred embodiment of the present invention to manufacture step-index POF with the cross-sectional structure shown in FIG. 4. The preferred diameter of the fiber core 1 is in the range of about 0.2 to about 0.96 mm. The preferred thickness of polymer cladding 2 is about 0.02 mm. The preferred thickness of the structural tubing 3 is in the range of about 0.1 mm to about 0.3 mm.

In another embodiment of the present invention, a flexible multi-core fiber can be produced. A cross-section of an embodiment of a multi-core fiber is shown in FIG. 5. The manufacturing process can include the simultaneous extrusion of seven fibers each incorporating a cross-linkable core, cladding polymer and structural polymer tube in the form of a hexagon. The individual hexagonal shaped fibers 1 can be directed to a cross-head die. A perfluorinated elastomer 2 can be co-extruded within a structural tube 3 to form the final multi-core fiber. The cross-head die may be located before or after the heated enclosure/rotating drum shown in FIG. 2. In an embodiment, the individual hexagonal fibers can move relative to each other within their elastomeric environment. As a result, during extreme bending of the multi-core fiber the strain on individual core fibers is reduced.

A jacket of polymer can be made to surround the structural tube for the purpose of producing a cable. This jacket can also increase heat resistance. As jacketing materials, polyolefins such as polyethylene, polypropylene, crosslinked polyolefin, polyvinylchloride, polyamides such as Nylon 12 or polyester elastomers such as polyethylene/methylene terephthalate copolymer may be used.

In another embodiment of the present invention, multiple step-index, graded-index and/or multi-core fibers may be extruded, post-processed and spooled simultaneously.

It is to be understood that the general chemistry and processes disclosed by the subject invention can be applied to partially fluorinated and perfluorinated materials for their incorporation into plastic optical fibers, in accordance with the subject invention.

It is to be understood that while the invention has been described in conjunction with the detailed description thereof, that the foregoing description is intended to illustrate and not limit the scope of the invention.

All patents, patent applications, provisional applications, and publications referred to or cited herein are incorporated by reference in their entirety to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A method of manufacturing a plastic optical transmission medium, comprising:
preparing a cylindrical volume having two or more concentric polymeric melts, wherein at least one of the two or more concentric polymeric melts comprises a cross-linkable material;
surrounding the two or more melts with a structural tubing wherein the structural tubing is concentric with the cylindrical volume;
maintaining the tube at a temperature and for a time period such that cross-linking occurs for the least one of the two or more melts within the structural tubing to produce a plastic optical transmission medium, wherein the structural tube retains its structural properties.

2. The method according to claim 1, wherein the method is continuous.

3. The method according to claim 1, wherein one or more of the two or more melts comprises an index-modifying additive.

4. The method according to claim 3, wherein the two or more melts comprise a first melt and a second melt, wherein the first melt comprises an index-increasing additive wherein the first melt forms a core of the plastic optical transmission medium.

5. The method according to claim 4, wherein the second melt comprises an index-lowering additive.

6. The method according to claim 3, wherein the two or more melts comprise a first melt and a second melt, wherein the second melt comprises an index-lowering additive.

7. The method according to claim 3, wherein the index-modifying additive comprises one or more transparent, non-reactive, low molecular weight diffusible additives.

8. The method according to claim 7, wherein the one or more transparent, non-reactive, low molecular weight diffusible additives are selected from the group consisting of diphenyl sulphide and methyl perfluoro octanate.

9. The method according to claim 1, wherein the two or more concentric polymer melts comprise two or more concentric transparent polymer melts.

10. The method according to claim 1, wherein the one of the two or more melts comprising the cross-linkable material forms a core of the plastic optical transmission medium.

11. The method according to claim 10, wherein the core diameter is in the range of about 0.2 mm to about 0.96 mm.

12. The method according to claim 10, wherein the cross-linkable material is a cross-linkable polymer mixture.

13. The method according to claim 12, wherein the cross-linkable polymer mixture comprises an amorphous organic, partially fluorinated or perfluorinated polymer.

14. The method according to claim 13, wherein the amorphous organic, partially fluorinated or perfluorinated polymer is selected from the group consisting of polycyclohexylmethacrylate, polyphenyl methacrylate, polytrifluoroethyl methacrylate, poly (2,2,3,3-tetrafluoroproply-α-fluoroacrylate), polystyrene, derivatives of polystyrene, polycarbonate, and derivatives of polycarbonate.

15. The method according to claim 12, wherein the cross-linkable polymer mixture comprises:
from 70 to 99 weight percent of polymerized units of methylmethacrylate;
from 0.1 to 28 weight percent of polymerized units of an asymmetric di-functional comonomer, wherein a first functional moiety of the comonomer has reacted to form a copolymer, wherein a second functional moiety of the comonomer is activated during maintaining the tube at a temperature and for a time period such that cross-linking occurs; and
from 0 to 15% of ethylmethacrylate or ethylacrylate.

16. The method according to claim 15, wherein the second functional moiety of the comonomer is activated at a temperature in the range of 120° C. to 180° C.

17. The method according to claim 15, wherein the first functional moiety of the comonomer is selected from the group consisting of methacrylate and ethyl acrylate.

18. The method according to claim 17, wherein the second functional moiety of the comonomer is activated at a temperature in the range of 140° C. to 160° C.

19. The method according to claim 18, wherein the comonomer is selected from compounds composed of a functional alkenyl group connected to (methyl)methacrylate group.

20. The method according to claim 19, wherein the comonomer comprises an allylmethacrylate.

21. The method according to claim 20, wherein the comonomer is propoxylated (a) allylmethacrylate.

22. The method according to claim 21, wherein the comonomer is propoxylated (2) allylmethacrylate.

23. The method according to claim 15, wherein the comonomer comprises ethylmethacrylate.

24. The method according to claim 15, wherein the cross-linkable polymer mixture further comprises at least 5 to 10 weight percent of ethylmethacrylate.

25. The method according to claim 12, wherein the cross-linkable polymer mixture has a weight average molecular weight of less than 60,000.

26. The method according to claim 12, wherein the cross-linkable polymer mixture has a weight average molecular weight of less than 50,000.

27. The method according to claim 12, wherein the cross-linkable polymer mixture has a weight average molecular weight of less than 40,000.

28. The method according to claim 12, further comprising adding a adding a high temperature initiator to the cross-linkable polymer mixture.

29. The method according to claim 1, wherein the two or more concentric polymeric melts comprises a first melt and a second melt, wherein the second melt forms a cladding of the plastic optical transmission medium, wherein the second melt comprises a material selected from the group consisting of polymers and copolymers of methacrylate derivatives with at least one hydrogen atom being substituted with a fluorine atom, polymers and copolymers of styrene derivatives with at least one hydrogen atom being substituted with a fluorine atom, fluorine substituted polycarbonate, polyvinylidene fluoride, vinylidene fluoride-tetrafluoroethylene copolymers, vinylidene fluoride-hexafluoropropylene copolymers, vinylidene fluoride-tetrafluoroethylene-hexafluoropropylene terpolymers, silicone resins, and ethylene-vinyl acetate copolymers.

30. The method according to claim 1, wherein the structural tubing comprises polyethylene terephalate (PET).

31. The method according to claim 1, wherein the thickness of the structural tubing is in the range of about 0.1 mm to about 0.3 mm.

32. The method according to claim 1, wherein preparing the cylindrical volume occurs at a temperature less than 210° C.

33. The method according to claim 1, wherein preparing the cylindrical volume occurs at a temperature less than 190° C.

34. The method according to claim 1, wherein preparing the cylindrical volume occurs at a temperature less than 180° C.

35. The method according to claim 1, wherein maintaining the tube at a temperature and for a time period such that cross-linking occurs for the least one of the two or more melts within the structural tubing comprises continuously passing the cylindrical volume surrounded by the structural tube through a heated enclosure.

36. The method according to claim 36, wherein the temperature is in the range of about 130° C. to about 170° C.

37. A method of manufacturing a plastic optical transmission medium, comprising:
preparing a cylindrical volume having two or more concentric polymeric melts, wherein at least one of the two or more concentric polymeric melts comprises a cross-linkable material;
surrounding the two or more melts with a structural tubing wherein the structural tubing is concentric with the cylindrical volume;
effecting cross-linking for the least one of the two or more melts within the structural tubing to produce a plastic optical transmission medium.
